(19) United States
(12) Patent Application Publication
(10) Pub. No.: US 2006/0008562 A1
(43) Pub. Date: Jan. 12, 2006

(54) Method for manufacturing bread crumbs

(75) Inventors: Mahesh Padmanabhan, Buffalo Grove, IL (US); David Carl Richards, Chicago, IL (US); Charles Andrew Leduc, Chicago, IL (US); Manoj Shah, Lindenhurst, IL (US); Robert J. Matthies, Cicero, IL (US); Keith D. Forneck, Streamwood, IL (US); Patricia Calabrese, Chicago, IL (US); Allan Ralph Olson, Kalamazoo, MI (US); Richard P. Scelia, Thornwood, NY (US)

Correspondence Address: KRAFT / FETF, 120 S. LASALLE STREET, SUITE 1600, CHICAGO, IL, 60603-3406, US

(73) Assignee: Kraft Foods Holdings, Inc.

(21) Appl. No.: 10/886,466

(22) Filed: Jul. 7, 2004

(51) Int. Cl. A21D 10/00

(52) U.S. Cl. 426/549

(57) ABSTRACT

A method for manufacturing bread crumbs is provided which does not use a conventional staling step. The ingredients of bread dough are mixed together and baked to form bread loaves. The unstated bread is then subjected to a heat conditioning step to create a bread crumb product with qualities similar to bread crumb products produced using a conventional staling step. Thereafter, the bread may be further processed to form smaller bread crumbs, dried, and packaged for sale. As a result, no time-consuming staling step is needed in order to produce a bread crumb product having desirable qualities similar to those of bread crumb products that have been subjected to a conventional staling step.

### FIELD OF THE INVENTION

The present invention is directed to an improved method for manufacturing bread crumbs and, more particularly, to an improved method for manufacturing bread crumbs using a heat conditioning step.

### BACKGROUND OF THE INVENTION

Bread particles, in form of crumbs and croutons, are used in a variety of food products, such as stuffing mixes, onion rings, breaded or coated meat patties, fish coatings, and chicken coatings. The bread particles are generally produced by baking bread according to conventional bread making procedures, usually with yeast as a leavening agent, allowing the baked bread to stale (generally requiring at least about 1 to 3 days or more), and then comminuting the stale loaf to the desired bread particle or bread crumb size. Thus, while staling is undesirable in loaves of bread intended to be sold directly to consumers, staling is a desirable and necessary step in the production of bread particle and bread crumb products. The two main components of staling in the production of bread crumbs are loss of moisture and the retrogradation of starch.

The loss of moisture from the bread loaves or bread crumbs is one component of the conventional staling of the bread loaves, particles, or crumbs. Water acts as a plasticizer in the bread, making the bread more flexible. Thus, as water is removed from the bread, through evaporation, migration, or any other process, the firmness of the bread increases. As a result, the loss of moisture from the bread contributes to the staling of the bread.

The second component of conventional staling is the retrogradation of starch contained within the bread loaves, crumbs, or particles. During baking, the starch present in bread dough or batter becomes gelatinized. That is, during the baking process the starch in the bread dough or batter is converted from an ordered, crystalline state in the dough or batter to a disordered, amorphous state in the baked bread. Upon cooling of the baked bread, the starch in the amorphous state begins to retrograde or re-order to form a more rigid crystalline state. This process results in the firming of the crumb texture in the bread and, thus, forms the second component in the staling of bread.

The primary drawback of the conventional bread crumb manufacturing process is that the time required for conventional staling is normally 24 to 72 hours or more, depending on the moisture content of the product. These long staling times necessarily involve a large storage space for the bread loaves. Additionally, these long staling times increase the manufacturing time required to produce the bread crumb product, cause interruptions in the manufacturing process, and reduce productivity or through put of the production line. Thus, the production of bread particles or crumbs has often been found to be economically inefficient and expensive due to the drawbacks of the conventional staling process. Of course, the storage space and conditions must be suitable for food products, thereby increasing costs even further; for example, these long staling times generally require the addition of mold inhibitor in the bread formula.

Even if accelerated conventional staling is utilized, the time required for the staling of the bread product is still 4 hours or longer. For example, U.S. Pat. No. 4,657,770 describes a two-stage process for accelerated staling of starchy products (including bread products), wherein the (a) the gelatinized starch is maintained at a temperature of −10 to 21° C. for a period of at least 2 hours (preferably 4 to 10 hours), and (b) then heated to a temperature of 30 to 80° C. and maintained at this temperature for a period of at least 2 hours (preferably 4 to 10 hours). Such a process, of course, generally requires chambers with precise temperature and humidity controls. Moreover, such a two-stage process requires more complicated process lines and still has longer processing periods than desired.

Thus, largely due to the long staling time required to make bread crumbs using conventional processes, a new process which is less time consuming and more economical is desirable. The present invention provides such an improved process while still providing the desired organoleptic and other properties obtainable in the conventional processes.

### SUMMARY OF THE INVENTION

The present invention provides a method for producing a bread crumb product which has similar texture, shape, and taste to conventional staled bread crumb products, wherein the present method does not use a conventional staling step and is, therefore, significantly faster that the conventional staled bread crumb process. The resulting bread crumbs may be used in the same manner as conventionally produced bread crumbs, such as, for example, in stuffing mixes, onion rings, breaded or coated meat patties, fish coatings, chicken coatings, and the like.

According to the present invention, a method for making bread or bread-like products is provided. The method for manufacturing bread particles or crumbs includes a heat conditioning step wherein the baked bread is held at a temperature of about 140 to about 270° F. for up to 3 hours (preferably about 10 minutes to about 2 hours) wherein the moisture content of the baked bread during the heat conditioning step is maintained at about 20 to 45 percent (preferably about 25 to about 40 percent). Preferably the heat conditioning step is carried out at a relative humidity of about 10 to about 75 percent and more preferably about 25 to about 40 percent. The moisture content of the baked product, the temperature of the product, and the desired final product texture govern the duration of this process step. During the heat conditioning step, there should be only a relatively small moisture loss for the baked product, and preferably a minimal moisture loss. This heat conditioning step allows the conventional staling step to be eliminated from the bread crumb or particle manufacturing process, resulting in significant time and cost savings, while still producing a bread crumb product having qualities similar to those of bread crumbs produced through the conventional process.

The present invention provides a method for manufacturing bread crumbs, said method comprising (1) providing an unstaled bread product; (2) subjecting the unstated bread product to a heat conditioning step to obtain a heat conditioned bread product, wherein the unstated bread product achieves an internal temperature of about 140 to about 270° F. during the heat conditioning step, wherein the moisture content of the unstated bread product during the heat conditioning step is maintained at about 20 to 45 percent, and wherein the heat conditioning step has a duration of less than about 3 hours; and (3) processing the heat conditioned bread product to form the bread crumbs, wherein the bread crumbs have organoleptic properties similar to conventional bread crumbs prepared from a staled bread product. This invention also relates to bread crumbs prepared by such a process using heat conditioning step, as described herein, but not using a conventional staling step.

### DETAILED DESCRIPTION

A wheat flour-based bread formula can be mixed to form a dough to be baked to provide a bread product for use in the present invention. Wheat flours, such as hard wheat flour and soft wheat flour, as well as flour blends having a wide range of protein content and quality may be used in the production of the dough. Likewise, while wheat flour is preferably used in connection with the present invention, other flours may be used, such as rice, corn, soy, oat, rye, whole wheat, barley, vital wheat gluten, and combinations thereof, either mixed with wheat flour or used in place of wheat flour, so long as the flour contains wheat gluten (from wheat flour or vital wheat gluten), soy protein from soy flour, and/or whey protein (e.g., from a milk substitute). The protein level of the flour used should be greater than about 4 percent, and preferably about 6 to about 12 percent. The flour is combined with other desired ingredients to form a well developed bread dough. For example, the formula may include flour (preferably wheat flour), sugar, shortening, salt, yeast, and water. Alternatively, any formula for bread or bread-like products may be followed to produce a bread dough. For example, lactose, fructose, maltose, corn syrup, and combinations thereof may be used as the sugar. The bread used in the present process may be prepared specifically for use in the present process or may be prepared for other uses (e.g., intended for resale as loaves, “seconds” from conventional bread baking processes, and the like) and then diverted to the present process.

The bread dough preferably includes yeast as a leavening agent. That is, yeast is provided such that the bread dough rises as air bubbles form within the dough when the yeast begins to ferment sugars in the bread dough. Thus, the yeast gives the bread dough a light, fluffy texture. For example, the yeast may be introduced into the dough mixture as dry yeast, instant dry yeast, hydrated yeast, and the like as well as combinations thereof. While the leavening agent used herein is preferably yeast, chemical leavening agents may also be used in connection with the present invention. For example, sodium, potassium, or ammonium bicarbonate in combination with a leavening acid (e.g., monosodium phosphate, cream of tartar, sodium aluminum phosphate, sodium acid pyrophosphate, dimagnesium phosphate, glucono-delta-lactone, sodium aluminum sulphate, lactic acid, malic acid, citric phosphate, dicalcium phosphate, and the like as well as combinations thereof) may be used as the leavening agent. Likewise, mechanical leavening may also be utilized in place of, or in combination with, yeast or chemical leavening agents.

Additionally, additives such as dough conditioners, flavoring, colorants, as well as other conventional bread ingredients may also be incorporated into the dough. Examples of dough conditioners include, but are not limited to, ascorbic acid, sodium or calcium stearoyl lactylate, diacetyl tartaric acid ester monoglyceride, polysorbate 80, and combinations thereof. Such dough conditioners enable faster hydration and mixing of the dough.

The dough is then proofed to allow the fermentation of the yeast, thus causing the bread dough to rise. The dough is typically proofed at a temperature of about ambient up to about 120° F. Preferably, the bead dough is proofed at or close to ambient temperatures and preferably at relatively high humidity (e.g., about 75 to about 95 percent relative humidity) generally for about 45 minutes to about 3 hours. Of course, the proofing time may be reduced, if desired, by using higher temperatures.

The dough mixture is then divided into loaves and baked. The size of the bread loaves may be selected according to the manufacturing needs of the producer and the type of product to be made. Likewise, the loaves may be placed into bread pans, or other similar cooking pans or dishes, to be baked as formed loaves, or the loaves of dough may be cooked without the use of pans or dishes to produce more “free-formed” loaves. The loaves may be baked in any way known in the art. For example, the bread dough may be baked for a time sufficient to raise the internal temperature of the loaf to about 200 to about 210° F. and to fully bake the bread dough, such that no unbaked dough is present within the loaf. As noted above, bread originally intended for other purposes (e.g., retail bread loaves) can be used in the present process if desired.

After baking, the bread (in the form of the original loaves or comminuted (e.g., slices, cubes, or other shapes) loaves) is subjected to a heat conditioning step. The heat conditioning step generally causes the internal temperature of bread to increase to about 140 to about 270° F., and more preferably about 155 to about 180° F. and has a duration of about 3 hours or less, and preferably about 2 hours or less. Higher moisture levels and higher temperatures during heat conditioning may reduce the duration of this process step. Both the temperature and duration of the heat conditioning step may be varied to provide conditions which are sufficient to form a bread crumb product with the desired qualities without the need for a conventional or accelerated staling step.

While not wishing to be limited by theory, it is believed that heat-induced cross-linking or thermosetting of the gluten proteins in the wheat flour is the primary mechanism responsible for developing the desired texture of the bread crumbs in the present invention. In contrast, in the conventional staling process, the desired texture is believed to be created through starch retrogradation and gelation. The process conditions used during the heat conditioning step of this invention, as well as the quality of the wheat flour (i.e., containing at least about 4 percent protein and preferably containing about 6 to about 12 percent protein) used in the bread dough, may influence the extent of this cross-linking reaction and, therefore, the texture of the final bread crumb product. The creation of heat-induced cross-linking of the gluten proteins within the bread loaves during the heat conditioning step allows for the production of a bread crumb product having qualities, such as texture and mouth-feel, that are similar to those of bread crumbs produced through the conventional staling process.

It has been found that the desired bread crumb texture (i.e., a texture similar to that of bread crumbs made using the conventional process) is best obtained by controlling three process conditions in the heat conditioning step: (1) the internal temperature the bread product during the heat conditioning step; (2) the moisture content of the bread product during the heat conditioning step is maintained at about 20 to about 45 percent and preferably about 25 to about 40 percent; and (3) the duration of the heat conditioning step. Preferably, the internal bread temperature during the heat conditioning step is raised to about 140 to about 270° F. The moisture content of the bread entering the heat conditioning step preferably is about 20 to about 45 percent and more preferably about 30 to about 40 percent. The moisture content of the bread after the heat conditioning step preferably is about 20 to about 45 percent and more preferably about 25 to about 35 percent. Thus, there is only a relatively small moisture loss, and preferably a minimal moisture loss, during the heat conditioning step. Generally such moisture loss, as determined by the absolute value of the moisture content of the product entering minus the moisture constant leaving the heat conditioning step, is less than about 7 percent and preferably less than about 3 percent. For example, if the moisture content of the product entering the heat conditioning step is about 35 percent and that leaving the heat conditioning step is about 30 percent, the moisture loss would be 5 percent. Finally, the duration of the heat conditioning step is less than about 3 hours, preferably about 10 minutes to about 2 hours, and more preferably about 1 to about 2 hours.

It is generally preferred that the bread product subjected to the heat conditioning step is relatively large in size (preferably in the form of whole bread loaves of greater than about 2 pounds, and more preferably about 1 to 4 pounds) to reduce the loss of moisture during the heat conditioning step. Although smaller bread pieces can be used, it will become more difficulty to maintain the moisture content during the heat conditioning step within the desired range. Of course, the length of, and the internal temperature of the bread during, the heat conditioning step must be sufficient to provide the desired textural qualities (e.g., firmness and chewiness) of the bread crumbs (i.e., similar to conventionally prepared bread crumbs using a staling step).

Furthermore, the particular combination of these process conditions during the heat conditioning step may be selected according to the desired textural properties of the final product. For example, bread crumbs having a desirable texture that is similar to that of bread crumbs produced using the conventional process may be produced by subjecting a baked bread product (e.g., whole bread loaves) having a moisture content of about 35 percent to the heat conditioning step and carrying out the heat conditioning step for about 1 to about 2 hours in order to raise the internal temperature to about 190° F. while maintaining the moisture content during the heat conditioning step in the range of about 33 to about 40 percent.

Following the heat conditioning step, the heat conditioned bread products may be further cut, diced, or otherwise comminuted to form smaller pieces if desired. The smaller pieces of the bread loaves are preferably dried to a moisture level of less than about 6 percent, and preferably about 4 to about 6 percent and then packaged for sale using conventional packaging techniques. Generally, this final drying step reduces the moisture content of the comminuted pieces from about 20 to 40 percent (as exiting from the heat conditioning step) to the final moisture content in a relatively short time period (i.e., less than about 60 minutes and preferably less than about 10 minutes). The process of this invention eliminates the need for a staling step and represents a considerable saving in both cost and time of production without sacrificing or impairing the desired properties of the resulting bread crumbs.

The level of firmness of the final bread crumb product may be modulated or modified by simply controlling the process conditions of the heat conditioning step. For example, higher temperatures, higher moisture levels, and/or longer treatment times during the heat conditioning step will generally result in firmer and chewier textures for the final product. As a result, bread crumb products for use in different mixes, coatings, or other compositions which require different bread crumb qualities may be manufactured using the same production equipment by only changing the process conditions, rather than the equipment itself. Thus, the number of production lines and amount of equipment needed to manufacture different types of bread crumb products may be reduced, further resulting in significant economic and space-saving benefits.

Additionally, the method of the present invention allows for increased flexibility in the use of alternative equipment in the production of bread crumb products. That is, various types of commercial heating equipment and technologies, both with or without humidity controls, may be used to conduct the heat conditioning step. In particular, a variety of heating equipment (e.g., electrical, gas-fired, microwave, and/or radio-frequency heating equipment) may be used in the heat conditioning step of the present invention. Although the use of humidity control during the heat conditioning step can be helpful in maintaining the moisture content in the desired range, it is not necessary. For example, the heat conditioning step using microwave heating can be accomplished in short time (in the order of a few minutes) while maintaining the moisture in the desired range without the need for humidity control. Where humidity control is desired during the heat conditioning step, any conventional method can be used. Once simple and preferred method to provide humidity control is to simply introduce steam into the heat conditioning unit (see, e.g., Example 3). By controlling the relative humidity within the heat conditioning unit near the desired humidity of the bread product during the heat conditioning step, the tendency of the bread product to dry out too much will be reduced.

Additives such as ascorbic acid and/or vital wheat gluten may also be added to the dough and used to further enhance this cross-linking effect. Likewise, it has been found that soy and whey proteins also appear to exhibit a similar heat-induced cross-linking reaction. Therefore, soy or whey proteins may also be used either as an additive to supplement the cross-linking of the wheat flour or as the primary source of such cross-linking. Finally, enzymes such as transglutaminase have also been found to enhance these cross-linking reactions, and therefore may be incorporated as additives to enhance the quality of the final bread crumb product. Of course, other additives (e.g., flavors, colors, other conventional bread additives, and the like) may be added if desired so long as they do not adversely affect the final bread crumb produced from the present process.

Thus, the use of a heat conditioning step in accordance with the present invention allows the production of bread crumb products without a staling step. The lack of such a time-consuming staling step allows for an increased throughput in the bread crumb manufacturing process. The absence of the staling step of the conventional process from the method of the present invention therefore allows for significant time and productivity savings in the manufacture of the bread crumb product and, therefore, results in significant economic benefits. Moreover, by eliminating the lengthy staling process, the risk of microbiological contamination is reduced.

Unless noted otherwise, all percentages are by weight.

### EXAMPLE 1

A bread dough (such as that used in the production of STOVE TOP® dressing) was prepared using a mixture consisting of 100 lbs wheat flour (a 50/50 blend of hard red winter and hard red spring flour with a protein content of about 12 percent), 6.95 lbs sugar, 2.63 lbs shortening, 2.41 lbs salt, 0.41 lbs dried yeast, 0.0014 lbs antioxidant (Tenox 4 from Eastman), and 57.9 lbs water. The dry ingredients were mixed in a dough mixer at low speed for about 2 minutes. After the water and shortening were added, mixing was continued at medium speed for about 8 minutes; the dough temperature was about 85° F. after completion of the mixing and the dough was fully developed.

The dough was proofed at ambient temperature for about 90 to about 15 minutes. The proofed dough was then divided into loaves of about 6.5 lbs each, rolled by hand, and placed in bread pans. The loaves were baked for about 80 minutes to achieve an internal temperature of about 200° F. using a continuous, 4 zone oven. The moisture content of the baked loaves was about 40 percent.

The baked loaves were cut into smaller pieces (eight equal pieces per loaf) and then subjected to a heat conditioning step in a continuous dryer (without humidity control) at about 235° F. and only minor air flow for about 112 The internal temperature of the bread loaves entering the heating chamber was about 190° F. and that leaving the heating chamber was about 150° F. (temperature decrease appears to be due to evaporative cooling). The moisture content of the heat conditioned loaves was about 28 percent.

After being subjected to the heat conditioning treatment, the resulting bread product was diced in to smaller pieces (about the same size as the STOVE TOP® dressing product) and dried to a final moisture content of approximately 5 percent in about 10 minutes in a 200° F. oven.

The texture of the dried crumbs was evaluated using the following procedure. Water (1½ cups with and ¼ cup margarine) was boiled in a saucepan. The inventive bread crumbs (152 g) were stirred into the boiling water. The saucepan was immediately removed from the heat source. After standing for about 5 minutes, and the dressing was fluffed with fork prior to evaluation. The inventive crumbs were found to provide a similar level of firmness and chewiness in the dressing product as a control made using bread crumbs prepared using a conventional staling process:

| Parameter | Control | Inventive |
|---|---|---|
| Moisture (%) | 5.0 | 4.5 |
| Density (lbs/ft³) | 16.8 | 17.6 |
| Shear (lb-force) | 119 | 170 |

The shear pressure was measured in a L.E.E. Kramer Shear Press Model FTC-300 (Cell # s00 4121 2079; Food Technology Corp., Rockville, Md.).

### EXAMPLE 2

Bread crumbs were prepared and evaluated using the same procedures as described in Example 1 except that the dough formulation was modified as follows: wheat flour (a 50/50 blend of hard red winter and hard red spring flour with a protein content of about 12 percent), 1.81 lbs sugar, 2.63 lbs shortening, 2 lbs salt, 0.31 lbs dried yeast, 0.0043 lbs antioxidant (Tenox 4 from Eastman), 0.84 lbs caramel color, and 57 lbs water. The inventive crumbs were found to provide a similar level of firmness and chewiness in the dressing product as a control made using bread crumbs prepared using a conventional staling process:

| Parameter | Control | Inventive |
|---|---|---|
| Moisture (%) | 5.0 | 4.0 |
| Density (lbs/ft³) | 16.8 | 17.7 |
| Shear (lb-force) | 119 | 182 |

### EXAMPLE 3

A dough was prepared comprising 100 lbs soft wheat flour (about 8% protein), 6.95 lb sugar, 0.41 lb dry yeast, 2.63 lb shortening, 2.41 lb salt, and 48 lb water. The dry ingredients were mixed at low speed for 2 minutes, water and shortening were added, low speed mixing was continued for 2 more minutes, followed by high speed mixing for and additional 6 minutes. The mixed dough had a temperature of about 87° F. The dough was proofed at room temperature for 90 minutes. The dough was divided in to 3 lb pieces and baked for 60 min in a reel oven set at 400° F. The internal loaf temperature was 206° F. at the end of baking and the moisture content was about 40 percent. The whole loaves were heat conditioned for 2 hours in a 200° F. heat conditioning unit using steam. The moisture level of the loaves exiting the heat conditioning unit was about 33 percent and the internal temperature 174° F. The loaves were diced and dried in 8 minutes in an electric dryer set at 200° F. to a final moisture content of about 5.5 percent.

The inventive crumb samples were evaluated using the same procedure as described in Example 1. The inventive crumbs were found to provide a similar level of firmness and chewiness in the dressing product as a control made using bread crumbs prepared using a conventional staling process:

| Parameter | Control | Inventive |
|---|---|---|
| Moisture (%) | 5.0 | 4.5 |
| Density (lbs/ft³) | 16.8 | 17.6 |
| Shear (lb-force) | 119 | 138 |

1. A method for manufacturing bread crumbs, said method comprising (1) providing an unstated bread product having a moisture content of about 20 to about 45 percent; (2) subjecting the unstated bread product to a heat conditioning step to obtain a heat conditioned bread product, wherein the unstated bread product achieves an internal temperature of about 140 to about 270° F. during the heat conditioning step, wherein the moisture content of the unstated bread product during the heat conditioning step is maintained at about 20 to about 45 percent, and wherein the heat conditioning step has a duration of less than about 3 hours; and (3) processing the heat conditioned bread product to form the bread crumbs having a moisture content of less than about 6 percent, wherein the bread crumbs have organoleptic properties similar to conventional bread crumbs prepared from a staled bread product.

2. The method according to claim 1, wherein the unstated bread product is one or more bread loaves.

3. The method according to claim 1, wherein the unstated bread product is one or more bread loaves which have been reduced in size.

4. The method according to claim 1, wherein the internal temperature achieved during the heat conditioning step is about 155 to about 200° F., wherein the moisture content of the unstated bread product during the heat conditioning step is maintained at about 25 to about 40 percent, and wherein the duration of the heat conditioning step is less than about 2 hours.

5. The method according to claim 2, wherein the internal temperature achieved during the heat conditioning step is about 155 to about 200° F., wherein the moisture content of the unstated bread product during the heat conditioning step is maintained at about 25 to about 40 percent, and wherein the duration of the heat conditioning step is less than about 2 hours.

6. The method according to claim 3, wherein the internal temperature achieved during the heat conditioning step is about 155 to about 200° F., wherein the moisture content of the unstated bread product during the heat conditioning step is maintained at about 25 to about 40 percent, and wherein the duration of the heat conditioning step is less than about 2 hours.

7. The method according to claim 4, wherein the internal temperature achieved during the heat conditioning step is about 155 to about 180° F. and wherein the duration of the heat conditioning step is about 1 to about 2 hours.

8. The method according to claim 5, wherein the internal temperature achieved during the heat conditioning step is about 155 to about 180° F. and wherein the duration of the heat conditioning step is about 1 to about 2 hours.

9. The method according to claim 6, wherein the internal temperature achieved during the heat conditioning step is about 155 to about 180° F. and wherein the duration of the heat conditioning step is about 1 to about 2 hours.

10. The method according to claim 1, wherein the unstated bread product comprises flour, sugar, shortening, salt, water, and a leavening agent.

11. The method according to claim 10, wherein the flour is wheat flour.

12. The method according to claim 10, wherein the leavening agent is a yeast.

13. The method according to claim 10, wherein the leavening agent is a chemical leavening agent.

14. The method according to claim 10, wherein the unstated bread product further comprises a dough conditioner.

15. The method according to claim 10, wherein the unstated bread product further comprises an additive to enhance cross-linking in the unstated bread product during the heat conditioning step.

16. The method according to claim 15, wherein the additive to enhance cross-linking is selected from the group consisting of soy protein, whey protein, ascorbic acid, vital wheat gluten, transglutaminase, and combinations thereof.

17. The method according to claim 1, wherein the processing of the heat conditioned bread product to form the bread crumbs includes drying the bread crumbs to a final moisture content of less than about 6 percent and then packaging the bread crumbs having the final moisture content.

18. The method according to claim 4, wherein humidity control is used during the heat conditioning step.

19. The method according to claim 5, wherein humidity control is used during the heat conditioning step.

20. The method according to claim 6, wherein humidity control is used during the heat conditioning step.

21. (canceled)

22. (canceled)

23. (canceled)
